(19) United States
(12) Patent Application Publication
(10) Pub. No.: US 2006/0010630 A1
(43) Pub. Date: Jan. 19, 2006

(54) Facial disc

(76) Inventor: Sun Man Tse, Carol Stream, IL (US)

Correspondence Address: Kao H. Lu, 686 Lawson Ave., Havertown, PA, 19083, US

(21) Appl. No.: 10/892,734

(22) Filed: Jul. 16, 2004

(51) Int. Cl. A47K 7/02; A61H 7/00

(52) U.S. Cl. 15/160; 601/137

(57) ABSTRACT

A facial buffering pad including a pad plate, a handle and a bristle portion for removing facial dirt and exercising face is provided. The pad plate includes a first face and an opposite second face. The handle is formed on the first face. The bristle portion includes a plurality of first bristles and a plurality of second bristles formed on the second face. The provided facial buffering pad is skin contact safe, environment friendly, non-toxic, odor free, water resistant, UV resistant, durable and flexible and antibacterial additive built in.

### FIELD OF THE INVENTION

This invention is related to a facial pad; more particularly, a silicon facial buffering pad for removing facial dirt and massaging facial skin and muscle.

### BACKGROUND

In everyday life, people usually wash their face with a towel, sometimes with the aid of a facial cleanser, to clean their face. A thorough facial cleansing to remove the residue is very important, especially when cosmetics are used. However, using only the towel in some situations, it may not be sufficient to effectively clean the face. Besides cleaning the face, people use various facial massage devices on their face to obtain various beauty effects. It can be more effective and economic to design a facial buffering pad that has the ability to clean as well as massage.

### SUMMARY

The preset invention is intended to provide a silicon buffering pad for facial cleaning and massaging, which can be used with most kinds of facial cleanser. Washing with this invention will help the user remove facial dirt and dead skin cells while massaging the facial area flesh, enhancing blood circulation and relaxing facial area muscle. Most importantly, this invention is designed with a material that can be used repeatedly. After each usage, one can rinse the pad clean and let it air dry.

Accordingly, the facial buffering pad provided by the present invention includes a pad plate, a handle and a bristle portion. The pad plate includes a first face and an opposite second face. The handle is formed on the first face. The bristle portion includes at least two different types of bristle patterns. The most preferred embodiment design has a plurality of first bristles and a plurality of second bristles formed on the second face. The facial buffering pad of the present invention is skin contact safe, environment friendly, non-toxic, odor free, water resistant, UV resistant, durable and flexible and has an antibacterial additive built in.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These, as well as other features of the present invention, will become apparent upon reference to the drawings wherein:

FIG. 1 illustrates a perspective view of a facial buffering pad according to the present invention;

FIG. 2 illustrates a side view of a facial buffering pad according to the present invention;

FIG. 3 illustrates a front view of a facial buffering pad according to the present invention;

FIG. 4 illustrates a rear view of a facial buffering pad according to the present invention; and

FIG. 5 illustrates a side view of a facial buffering pad according to another preferred embodiment of the present invention.

### DETAILED DESCRIPTION OF THE PREFERRED EMBODIMENTS

References will now be made in detail to the preferred embodiments of the present invention, examples of which are illustrated in the accompanied drawings. Wherever possible, the same reference numbers are used in the drawings and the description to refer to the same or like parts.

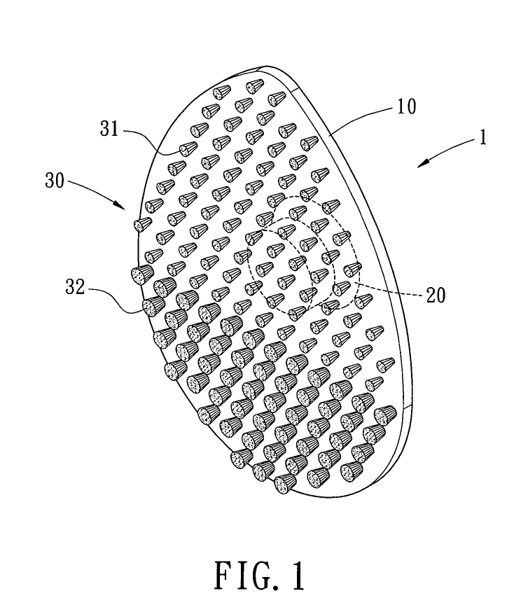

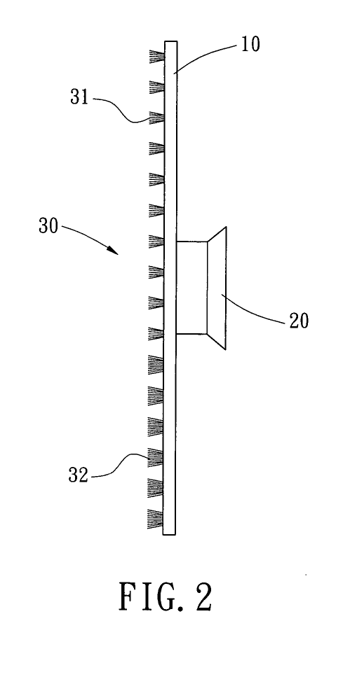

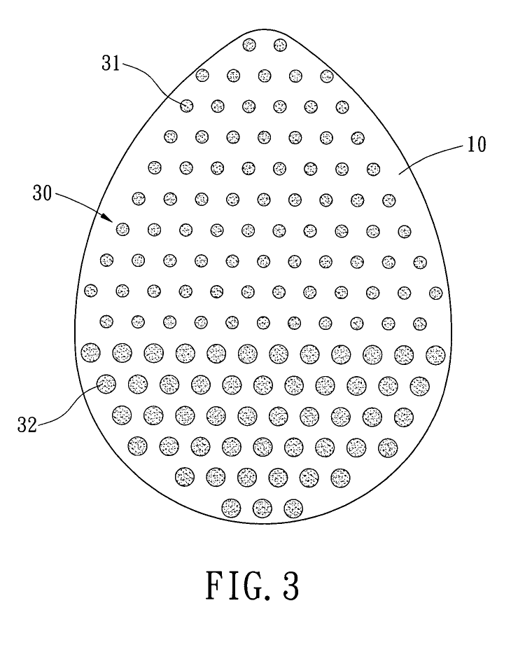

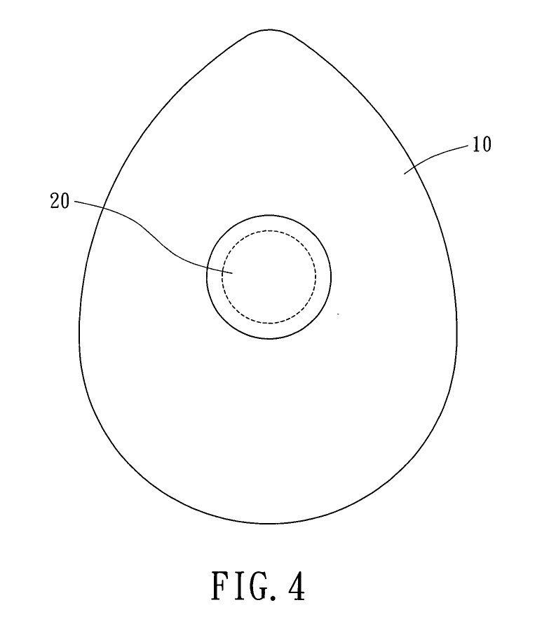

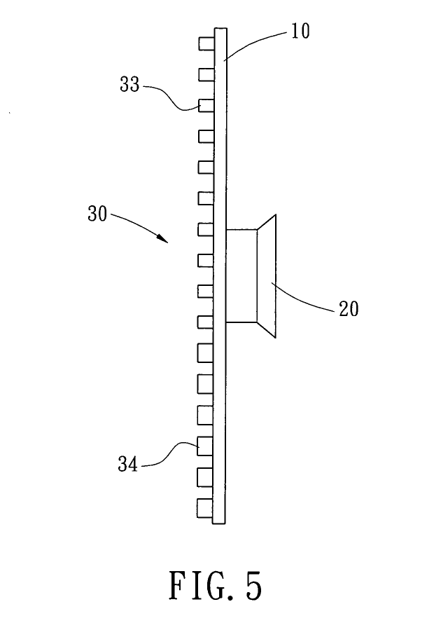

Please refer to FIG. 1 through FIG. 4, a facial buffering pad (present invention). The buffering pad [1] includes a pad plate [10], a handle [20] and a bristle portion [30]. The pad plate [10] is made of silicon material, such as a silicon rubber, and has a drop shape. Further, the pad plate [10] includes a first face [11] and an opposite second face [12]. The silicone rubber is made from the mixture of Dinethy methyl vingl siloxane, dimethy vingl terminated and cyclo siloxane reaction products with silica dimethyl polysiloxane silamol. An anti-bacterial agent, such as AGS700 is added to the silicone rubber. The handle [20] is mounted to the first face [11] of the pad plate [10] for easy grasping. In one preferred embodiment, the handle [20] can be also made of silicon material, such as a silicon rubber, and integrally formed with the pad plate [10]. Moreover, the bristle portion [30] is located on the second face [12] to have contact, which is safe for users' faces, where the hardness of the bristle range between 15-40 degree. In this preferred embodiment, the bristle portion [30] includes two different arrangements of bristles [31] and [32] formed a substantial portion of surface of the second face [12] of the pad plate [10]. A plurality of thinner bristles [31], each with a diameter of about 0.5-1.0 millimeters, are well organized and arranged on the upper portion of the second face [12]. The invention also has a plurality of thicker bristles [32], each with a diameter of about 1.0-2.5 millimeters, well organized and arranged on the lower portion. As such, an image line to separate the thinner bristles [31] and the thicker bristles [32] is substantially located at the widest portion of the drop-shaped pad plate [10]. Consequently, users can conveniently utilize the thinner bristles [31] or the thicker bristles [32] of the bristle portion [30] to apply for different face regions. In one preferred embodiment, as shown in FIG. 3, the bristles [31] and [32] of the bristle portion [30] can be directly planted on the second face [12] of the pad plate [10]. In another preferred embodiment, as shown in FIG. 5, the bristle portion [30] can be also made of silicon material, such as a silicon rubber, and integrally formed with the pad plate [10]. Pluralities of first protrusions [33] and second protrusions [34] of the bristle portion [30] have different sizes. For example, each first protrusion [33] has a larger diameter than the second protrusion [34].

Accordingly, the facial buffering pad [1] provided by the present invention can be integrally formed or partially integrally formed to be made from the material being non-toxic, odor free, water resistant, UV resistant, durable and flexible, antibacterial additive built in and/or high heat resistant, such as about 475 degree Fahrenheit.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

What is claimed is:

1. A facial buffering pad, comprising:
a pad plate including a first face and an opposite second face;
a handle formed on the first face for grasping; and
a bristle portion including at least two different types of bristle patterns to clean and
message a user's face.

2. The facial buffering pad of claim 1, wherein a bristle portion including at least two
different types of bristle patterns further comprising a plurality of first bristles and a
plurality of second bristles formed on the second face.

3. The facial buffering pad of claim 2, wherein the pad plate is made of silicon rubber.

4. The facial buffering pad of claim 3, wherein the pad plate has a drop shape.

5. The facial buffering pad of claim 2, wherein the handle and the pad plate are integrally formed.

6. The facial buffering pad of claim 2, wherein the bristle portion and the pad plate are integrally formed.

7. The facial buffering pad of claim 2, wherein each of the first bristles has a diameter about 0.5-1.0 millimeters.

8. The facial buffering pad of claim 2, wherein each of the second bristles has a diameter about 1.0-2.5 millimeters.

9. The facial buffering pad of claim 2, wherein the first bristles and the second bristle are
formed on substantially the whole surface of the second face.

10. The facial buffering pad of claim 9, wherein the first bristles are formed on the top
portion of the second face and the second bristles are formed on the lower portion thereof.

11. The facial buffering pad of claim 2, wherein each of the first bristles has a length about 2.5 millimeters.

12. The facial buffering pad of claim 2, wherein each of the second bristles has a length about 2.5 millimeters.

13. The facial buffering pad of claim 2, wherein the density of the first bristles is different from the density of the second bristles.
a voltage source; a sensing amplifier; a writable memory; and a microprocessor;
wherein the voltage source provides an operation voltage to an inspection strip electrode, and the sensing amplifier is connected to another electrode of the inspection strip, and when an analyte-containing fluid is dripped in the reaction well, an output signal corresponding to an sensing current is generated;
wherein the key code strip, having a first built-in test circuit, can be plugged in the slot in advance to load a plurality of parameters and an operation procedure controlling operation of the biosensing meter from an EEPROM of the key code strip into the writable memory of the biosensing meter, the microprocessor then responds the operation procedure and parameters to determine a plurality of voltages with a predetermined lasting time to be used by the meter for future measuring purpose;
wherein the microprocessor working with the sensing amplifier using the newly downloaded procedure and parameters generates an analysis result measured from the analyte-containing fluid, then converts and displays the analysis result in human readable form; and
the microprocessor can use the first built-in test circuit of the key code strip or the second built-in test circuit of the correction strip to further calibrate the parameters and the operation procedure will be used.

4. The biosensing meter according to claim 1, where the first test circuit of the key code strip is a resistor circuit.

5. The biosensing meter according to claim 1, where the second test circuit of the correction strip is a resistor circuit.
